(19) United States
(12) Patent Application Publication
(10) Pub. No.: US 2026/0306323 A1
(43) Pub. Date: Oct. 8, 2026

(54) Reconfigurable System for Supporting a Person with Reduced Mobility

(71) Applicant: Fabrizio Liparota, Torino (IT)

(72) Inventor: Fabrizio Liparota, Torino (IT)

(21) Appl. No.: 19/481,822

(22) PCT Filed: Jul. 12, 2024
(86) PCT No.: PCT/EP2024/069926

§ 371 Date: Nov. 5, 2025

(30) Foreign Application Priority Data
Jul. 12, 2023 (IT) 202023000003045

(51) Int. Cl. A61G 5/14; A61G 3/02; A61G 5/04; A61G 5/10; A61G 5/12; A61G 7/10

(52) U.S. Cl. CPC A61G 5/14; A61G 3/02; A61G 5/04; A61G 5/1056; A61G 5/125; A61G 7/1019; A61G 7/1048; A61G 7/1059; A61G 7/1076; A61G 2200/34; A61G 2200/52

(57) ABSTRACT

Reconfigurable system for supporting a person with reduced mobility A reconfigurable system (10) for supporting a person with reduced mobility, comprises a frame (12) comprising a first arm (14) and a second arm (16), the 5 frame (12) further comprising a third arm (18) extending along a transverse direction to the longitudinal direction (x), each lateral support device comprising a lifting device (24) and an armrest (26) connected to a respective distal end (24a) of the lifting device (24) and configured to interface with an armpit of the supported person to support at least part of the weight of the 10 supported person; a leg-rest for supporting at least part of the underside of said person; a first driver (28) configured for operating each lifting device (24) of the lateral support devices (20, 22); wheels connected to the frame (12), of which two front wheels (30a, 30b) are connected at the respective front ends (14a, 16a) of the first arm (14) and second arm (16) and two rear wheels (30c, 15 30d) are connected at the respective rear ends (14b, 16b) of the first (14) and second (16) arms; a second driver (32) configured for driving at least two of said wheels; and a collapsible seat; wherein the frame has a rear portion which comprises a vacant space located between said first and second arms; said collapsible seat being configured to collapse into at least part of a front portion 20 of the frame which, when collapsed, increases the vacant space located in said rear portion; said system being further configured so that the person is supported by said armrest and said leg-rest when the seat is collapsed in order to facilitate, in use, the interaction of the supported person with an object occupying, in use, said vacated space.

### FIELD OF THE INVENTION

The present invention relates to a reconfigurable system for supporting a person with reduced mobility. In particular, but not exclusively, the present reconfigurable system is usable by individuals with reduced mobility due to advanced age or suboptimal physical conditions.

### BACKGROUND TO THE INVENTION AND PRIOR ART KNOWN TO THE APPLICANT

Systems are known for the seating and supporting of individuals with limited mobility due to advanced age or particular pathologies that induce a suboptimal physical condition. These systems are also designed to facilitate the action of getting up and/or sitting down and to assist the independent walking of such persons.

Seating and supporting devices known in the art are typically devices in which the patient is supported only at his armpit during sitting or when the patient needs to stand up. See, for example, the patent publications CN 217472272 U, CN 115068232 A, CN 115024904 A and CN113101080 B which disclose seating and support systems equipped with small wheels to enable the movement of individuals with reduced mobility and also equipped of lateral supports arranged to support the patient's arms during sitting, as well as arranged to rise and engage with the patient's armpit when the patient needs to stand up, facilitating this operation.

Moreover, seating and supporting devices known in the art are devices in which the patient has to manually operate the lateral supports when ascending and/or descending, a condition that is particularly inconvenient for patients who—in addition to having reduced mobility—also have muscular weakness or bone fragility related to their physical condition or age.

### SUMMARY OF THE INVENTION

A general aim of this invention is to create a system for the support and walking assistance of persons with reduced mobility that can be easily used by a large number of people with a non-optimal physical condition.

A further aim of the invention is to realise a system for the support and walking assistance that can be used for different daily activities of the patient with limited mobility.

In a first broad independent aspect, the invention provides a reconfigurable system for supporting a person with reduced mobility, comprising a frame comprising a first arm and a second arm extending along a longitudinal direction, parallel and spaced apart, each having a front end and a rear end, the frame further comprising a third arm extending along a transverse direction to the longitudinal direction, arranged so as to rigidly connect said first and second arms to each other; a first lateral support device and a second lateral support device, at least one lateral support device comprising: a lifting device operable between at least one operating position in which the lifting device is extended along a vertical direction, and a rest position in which the lifting device is collapsed, and an armrest connected to a respective distal end of the lifting device and configured to interface with an armpit of the supported person to support at least part of the weight of the supported person; a leg-rest for supporting at least part of the underside of said person; a first driver configured for operating each lifting device of the lateral support devices; four wheels connected to the frame, of which two front wheels are connected at the respective front ends of the first arm and second arm and two rear wheels are connected at the respective rear ends of the first and second arms; a second driver configured for driving at least two of said wheels; and a collapsible seat; wherein the frame has a rear portion which comprises a vacant space located between said first and second arms; said collapsible seat being configured to collapse into at least part of a front portion of the frame which, when collapsed, increases the vacant space located in said rear portion; said system being further configured so that the person is supported by said armrest and said leg-rest when the seat is collapsed in order to facilitate, in use, the interaction of the supported person with an object occupying, in use, said vacated space.

This configuration is particularly advantageous as it allows the person to be supported and more readily interact with a toilet, bed or car seat. It also provides a particularly compact solution ideal for transportation and for stowing away. It is also particularly advantageous in terms of safety and practicality. Further aspects of these advantages will now be provided in certain embodiments of the invention.

In a further subsidiary aspect, the reconfigurable system further comprises a third driver to drive the transformation of the seat into and from its collapsed configuration.

In a further subsidiary aspect, the leg-rests extend from the first and second lateral support devices and are configured to interface with a knee or upper underside region of the person's legs.

In a further subsidiary aspect, the leg-rests are formed from a junction member extending between said lateral support devices.

In a further subsidiary aspect, the system further comprises a driver for displacing the leg-rest from a position where it is spaced from a position of engagement with the underside of a supported person's leg to a position of engagement with the underside of a supported person's leg.

In a further subsidiary aspect, at least one of the armrests is adjustably connected to a lifting device; whereby the distance between the two armrests is adjustable.

In a further subsidiary aspect, the longitudinal direction and the transverse direction define a horizontal plane and the vertical direction is perpendicular to the horizontal plane, where the lifting devices of the first lateral support and second lateral support device each comprise a proximal element joined respectively to the first arm and second arm of the frame and at least one distal element telescopically movable with respect to the relevant proximal element along the vertical direction, away from, or towards, the plane horizontal.

In a further subsidiary aspect, the lifting device of the first lateral support device and the lifting device of the second lateral support device are pivotally mounted in relation to the frame.

In a further subsidiary aspect, the first lateral support device and the second lateral support device are in the operating position, the armrests are substantially parallel to the horizontal plane and can be rotated about an axis perpendicular to the plane.

In a further subsidiary aspect, the reconfigurable system further comprises two small wheels having a diameter smaller than the diameter of the two rear wheels and arranged respectively, one on the first arm and one on the second arm in one distal position with respect to said rear wheels; in which said two rear wheels are rotatably supported on swivel pins between a first position where the rear wheels are perpendicular to the plane and a second position in which the rear wheels are parallel to the plane.

In a further subsidiary aspect, the seat comprises a backrest each connected to the frame by a plurality of intermediate elements.

In a further subsidiary aspect, the reconfigurable system comprises two lower support elements connected respectively to the first and second lateral support device and predisposed for support the supported person's lower limbs.

In a further subsidiary aspect, the first driver and the second driver can be operated by the supported person via a control device placed on board the reconfigurable system and/or can be operated remotely via an application.

In a further subsidiary aspect, the system comprises a single armrest which is sized and shaped to extend between the first and the second lateral support device in order to engage with the supported person's armpit.

In a further broad aspect, the invention provides a loading equipment for loading a reconfigurable system in a cargo space of a motor vehicle, comprising a reconfigurable system according to any of the preceding aspects; a loading system configured to be arranged in a loading space of a motor vehicle and engage with said reconfigurable system; wherein the loading system comprises a first element fixed and arranged in the loading space of the motor vehicle and a plurality of second elements telescopically mobile with respect to the fixed element, prepared to engage with the armrests of the lateral support devices of the reconfigurable system, and configured to have a rest position in which the plurality of second elements are overlapped and an operational position in which the plurality of second elements are extended.

### BRIEF DESCRIPTION OF THE FIGURES

The features and advantages of the present invention will become clearer from the following detailed description, given purely by way of non-limiting example with reference to the attached drawings, in which:

FIG. 1 illustrates a side view of a reconfigurable system according to a first embodiment of the invention in which the lifting devices are in a rest position;

FIG. 2 illustrates a front view of the reconfigurable system of FIG. 1;

FIG. 3 illustrates a side view of a reconfigurable system according to the present finding in which the lifting devices are in an operating position;

FIG. 4 illustrates a frontal view of the reconfigurable system of FIG. 3;

FIG. 5 is a side view of a second embodiment of the reconfigurable system;

FIG. 6 is a side view of a third embodiment of the reconfigurable system;

FIG. 7 is a side view of the reconfigurable system of FIG. 1 or 2 in which a seat and a backrest are folded into a rest position;

FIG. 8 is a side view of the reconfigurable system of FIG. 7 in which the lifting devices are in an operating position;

FIG. 9 is a side view of the reconfigurable system of FIG. 5 in which the backrest seat and lateral support devices are collapsed;

FIG. 10 is a front view of the reconfigurable system of FIG. 9;

FIG. 11 is a top view of the reconfigurable system of FIG. 9 or 10.

FIG. 12 is a perspective view of the lateral support devices. FIG. 13 is a frontal view of the lateral support devices of FIG. 12.

FIG. 14 is a frontal perspective view of the lateral support devices coupled with the lower support device.

FIG. 15 is a rear perspective view of the lateral support devices coupled with the lower support device.

FIG. 16 is a frontal perspective view of the lateral support device coupled with the horizontal support device in its open position

FIG. 17 is a frontal perspective view of the lateral support device coupled with the horizontal support device in its closed position

### DETAILED DESCRIPTION OF THE FIGURES

Referring to the drawings, a reconfigurable system 10 for the support and ambulation of a person with reduced mobility comprises a frame 12, a first 20 and a second 22 lateral support device, first driving means 28 or driver arranged to drive the first lateral support device 20 and the second lateral support device 22, four wheels and second driving means or driver 32 arranged to drive at least two of the four wheels.

The frame 12 comprises a first arm 14 and a second arm 16 extending along a longitudinal direction x, they are parallel and spaced apart, and each have a front end 14a, 16a and a rear end 14b, 16b. The frame 12 further comprises a third arm 18 which extends along a transverse direction z, which is perpendicular to the longitudinal direction x.

The third arm 18 is arranged to rigidly connect the first arm 14 and the arm second 16 to each other and is connected with the first arm 14 and the second arm 16 at a relative centreline position of the first arm 14 and the second arm 16. In other words, the frame 12 may have a substantially H-shape, with the first arm 14 and second arm 16 extending along the longitudinal direction x and the third arm 18 extending along the transverse direction z. Such an H-shape of the frame 12 provides greater stability to the reconfigurable system 10 and also allows the reconfigurable system 10 to approach seating elements 11 such as sanitary ware or chairs on which the user or supported person may wish to sit on by placing the arms 14, 16 lateral to the seating element 11.

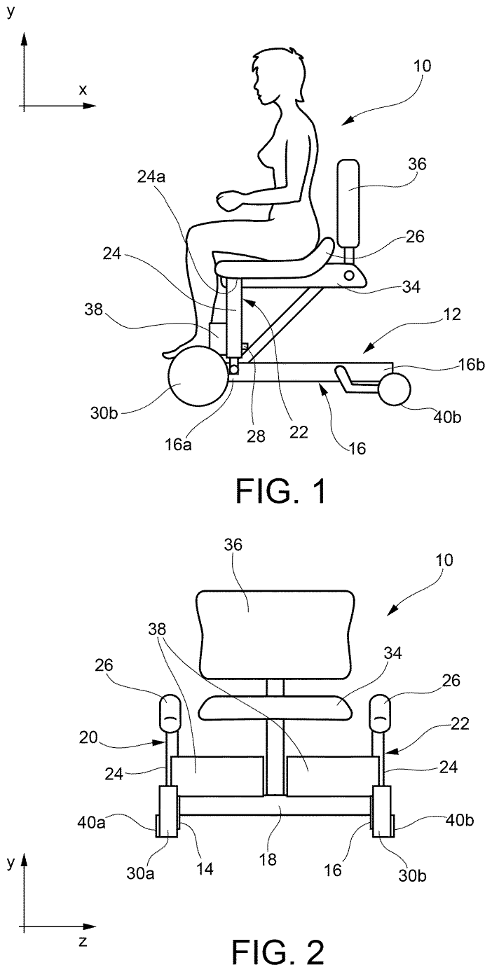

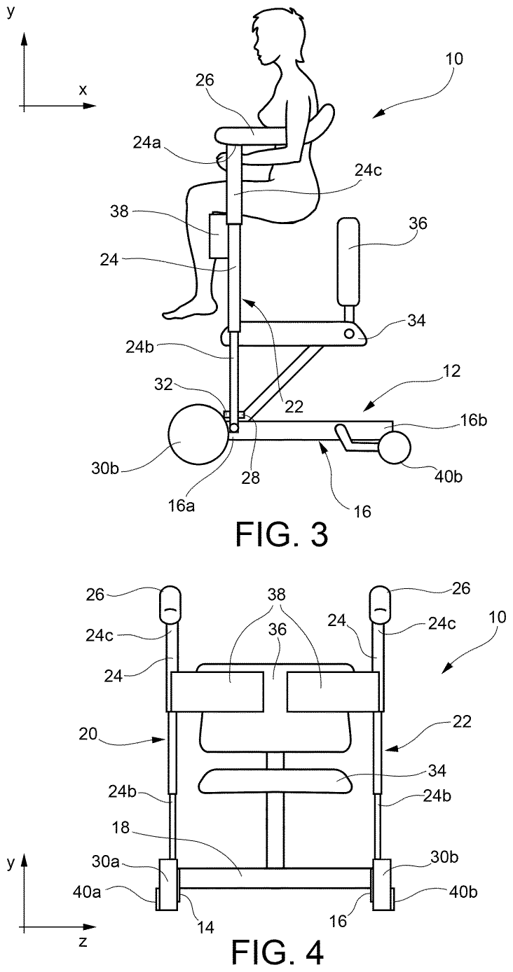

The first arm 14 and the second arm 16 of the frame 12 may have, for example, a length in the range from about 70 cm to about 90 cm along the longitudinal direction x and the third arm 18 of the frame 12 may have, for example, a length in the range from about 50 cm to about 70 cm along the transverse direction z. Preferably, the first arm 14 and second arm 16 have a length of 82 cm and the third arm 18 has a length of 58 cm. The first lateral support device 20 and the second lateral support device 22 of the reconfigurable system 10 each in turn comprise a lifting device 24 and an armrest 26. The lifting device 24 is operable between at least one rest position in which the lifting device 24 is collapsed (visible in FIGS. 1 and 2) and an operating position in which the lifting device 24 is extended along a vertical y-direction (visible in FIGS. 3 and 4). As it will be described later, other positions for lifting device 24 can be provided in accordance with the present invention.

In the resting position, the lifting device 24 may have, for example, a length in the range of approximately 60 cm to approximately 80 cm along the vertical direction y. Preferably, the lifting device 24 in the resting condition has a length of about 70 cm.

Each armrest 26 is connected to a respective distal end 24a of the lifting device 24 and is configured to interface with an armpit of the supported person to support the weight of the supported person.

Preferably, the armrest 26 has an elongated shape and when the lifting device 24 is in the resting condition, the armrest 26 is parallel to the longitudinal direction x.

The lifting devices 24 may be made of a metal material, for example steel, so as to have sufficient strength to support the weight of the person using the reconfigurable system 10 and who may be supported and/or lifted by it, while the armrests 26 may advantageously be made of or covered with soft material, for example padded or resilient material, such that they are comfortable for the person using them as support.

The first driver 28 are configured for driving each of the lifting device 24 of the lateral support devices 20, 22.

Preferably, the first driver 28 may be coupled with the lifting device 24 to drive the first side support device 20 and the second side support device 22.

For example, the lifting devices 24 may be hydraulic or electromechanical linear actuators and the first driver 28 may be an electric motor. In further embodiments, the driver may comprise a controller and a battery.

In an embodiment, the first driver 28 and the second driving means 32 are operable by the supported person via a device control (not shown, but known in and of itself), preferably electronic, arranged on board the reconfigurable system 10 in such a way as to allow the supported person to move freely and independently during use of the reconfigurable system 10. For example, the first driver 28 and the second driver 32 may be controlled by means of a joystick.

In addition or alternatively, the first driver 28 and the second driver 32 may be remotely operable in such a way as to allow a third person to pilot the reconfigurable system 10 or the supported person himself to move the reconfigurable system 10 when he is not on board the reconfigurable system 10 and wishes to move it closer to or further away from him to facilitate ascent or descent. For example, the first driver 28 and the second driver 32 can be controlled via a smartphone application.

The four wheels are connected to the frame 12 in such a way as to provide two front wheels 30a, 30b connected at the respective front ends 14a, 16a of the first 14 and second 16 arm and two rear wheels 30c, 30d connected at respective rear ends 14b, 16b of the first 14 and second 16 arm, as illustrated in FIGS. 1 and 3.

Preferably, the two front wheels 30a, 30b and the two rear wheels 30c, 30d have the same or similar diameters (as shown in FIG. 6). Even more preferably, the diameter of the four wheels is in the range of 10 cm to 20 cm.

The second driver 32 are configured to drive at least two of the four wheels in such a way as to allow for forward and reverse movements of the reconfigurable system 10.

In a preferred embodiment, each of the lifting devices 24 of the first side support device 20 and the side support device 22 comprises a proximal member 24b, joined respectively to the first frame arm 14 and the second frame arm 16, and at least one distal member 24c that is telescopically movable relative to the respective proximal member 24b along the vertical y-direction.

The longitudinal direction x and the transverse direction z jointly define a horizontal plane xz passing through both, and the vertical direction y is perpendicular to the horizontal plane xz. In an embodiment, the distal elements 24c of the lifting devices 24 of the first lateral support device 20 and of the second lateral support device 22 may move relative to their proximal elements 24b along the vertical y direction. In particular, the distal elements 24c of the lifting devices 24 of the first 20 and second 22 lateral support device move away from the horizontal plane xz to move from a rest position to an operating position of the first lateral support device 20 and the second lateral support device 22 and move towards the horizontal plane xz to move from an operating position to a rest position of the first lateral support device 20 and the second lateral support device 22.

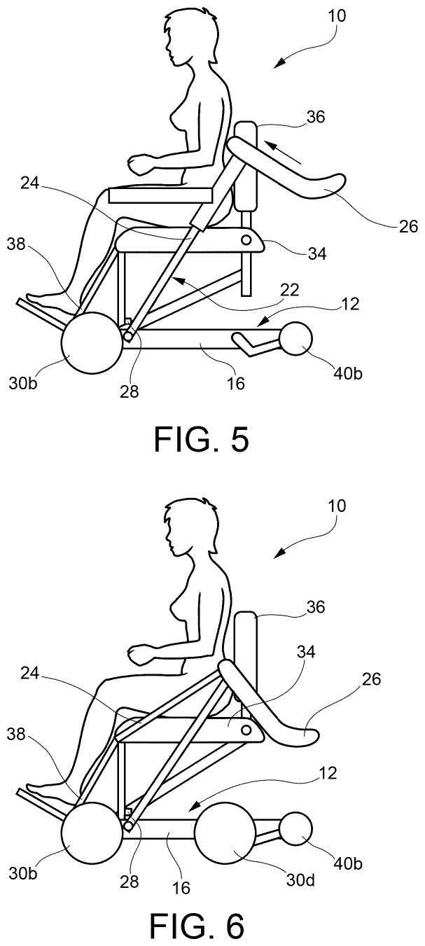

As illustrated in the embodiments of FIGS. 5 and 6, the lifting device 24 of the first lateral support device 20 and the lifting device 24 of the second lateral support device 22 can be rotatably mounted with respect to the frame 12.

In the embodiment of FIG. 5, the lifting devices 24 of the first lateral support device 20 and the second lateral support device 22 may be directly connected to the frame 12 and pivotally mounted with respect thereto.

In the embodiment of FIG. 6, the lifting devices 24 of the first lateral support device 20 and the second lateral support device 22 may be connected to the frame 12 by a fixed intermediate member and be rotatable with respect thereto and with respect to the frame 12.

As illustrated in FIGS. 3 and 4, when the first lateral support device 20 and the second lateral support device 22 are in the operating position, i.e. extended along a vertical direction y, the armrests 26 may be substantially parallel to the horizontal plane xz. In addition, in such operative position, the armrests 26 may be rotated about an axis perpendicular to the plane xz in such a way as to closely approach and clamp the torso of the supported person more tightly who is using the reconfigurable system 10 and provide greater stability for the supported person, for example, when walking.

Such rotation of the armrests 26 into the operating position can be performed manually by the supported person who is using the reconfigurable system 10. Manual rotation of the armrests is, for example, enabled by elastic or biased elements present between the armrest and the lifting device 24.

Alternatively, for the rotation of the armrests 26, a control system arranged to be interfaced with the supported person may be provided so that the supported person can impart the rotation command to the armrests 26.

A form of embodiment of the present invention may provide that the reconfigurable system 10 further comprises two small wheels 40a, 40b having a diameter smaller than the diameter of the two rear wheels 30c, 30d and arranged respectively on the first 14 and second 16 arm in a position distal with respect to the rear wheels 30c, 30d (as visible in FIG. 6).

In this embodiment, the two rear wheels 30c, 30d can be pivotally supported on pivot pins between a first position in which the rear wheels 30c, 30d are perpendicular to the plane xz (see FIG. 6) and a second position where the rear wheels 30c, 30d are parallel to the plane xz.

Preferably, when the rear wheels are in the second position, they may be parallel to the plane xz and arranged inferiorly to the chassis 12 in such a way as not to create lateral obstructions to the chassis which could limit the movement of the reconfigurable device 10. Moreover, such a condition advantageously allows the supported person to bring the rear part of the reconfigurable system 10 closer to a seating element 11 in the home, for example a bed or a sofa or a suspended sanitary, by passing the rear part of the frame 12 underneath the seating element and move more easily from the reconfigurable system 10 to the seat.

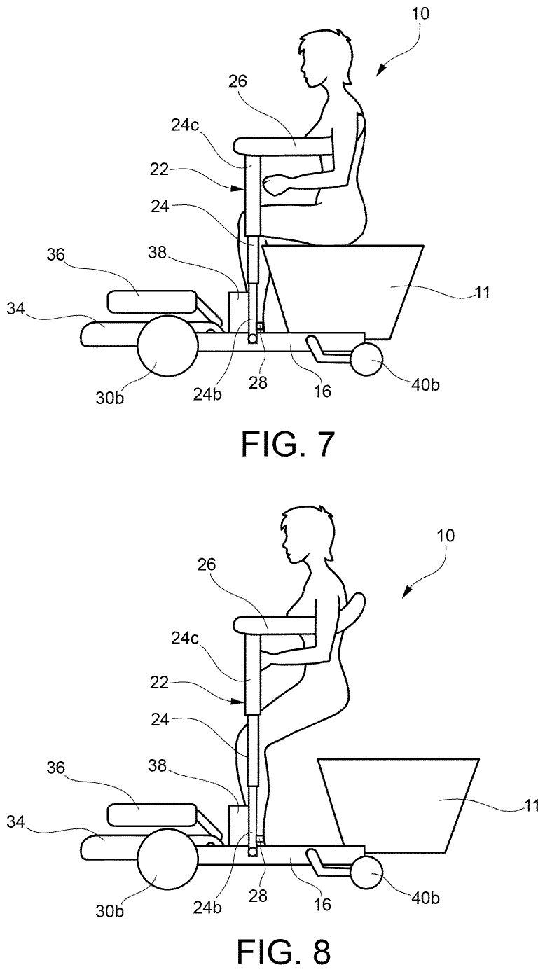

As illustrated in the figures, the reconfigurable system 10 of the present invention may further comprise a seat 34 and a backrest 36, each connected to the frame 12 by a plurality of intermediate elements. The seat 34 and the backrest 36 may be movable relative to the frame 12 such that they may be arranged folded or collapsed into a rest position, as illustrated in FIGS. 7-11, or unfolded into an operative position to accommodate the supported person in a seated position, as illustrated in FIGS. 1-6.

Preferably, when folded in the rest position, the backrest 36 and the seat 34 can be collapsed into the front part of the reconfigurable system 10 (see FIGS. 7 and 8) in such a way as not to create excessive bulk in the rear part of the reconfigurable system 10 which remains, therefore, suitable to be tucked under of seating elements such as sofas or beds.

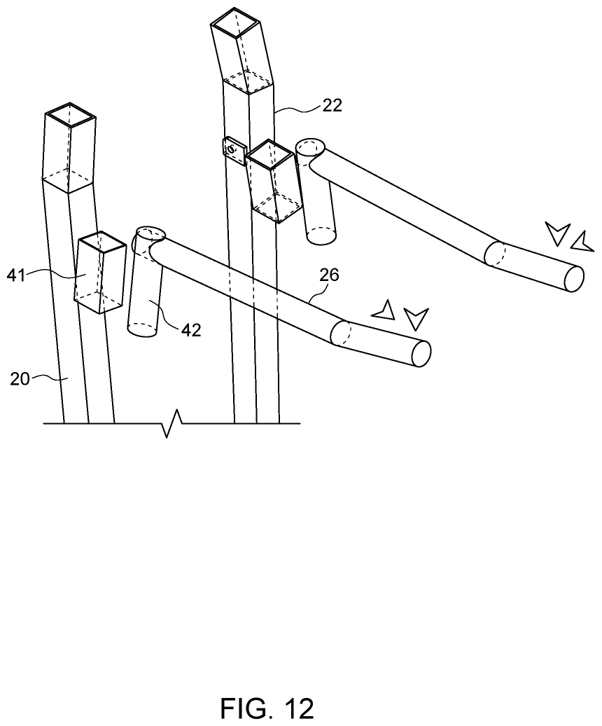

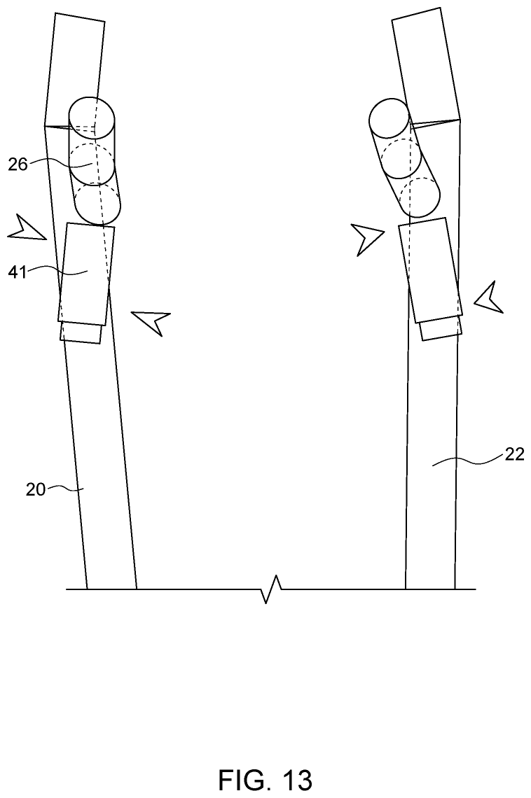

In preferred embodiments, the frame has a rear portion which comprises a vacant space 11 located between the first and second arms 14, 16. The collapsible seat is configured to collapse into at least part of a front portion of the frame (see FIG. 8) which, when collapsed, increases the vacant space located in the rear portion. The system is further configured so that the person is supported by the armrest 26 and the leg-rest 38 (of the kind shown in FIG. 4 or of the kind shown in FIG. 12 onwards). The seat is collapsed in order to facilitate, in use, the interaction of the supported person with an object occupying, in use, the vacated space 11.

The present reconfigurable system 10 may further comprise two lower support elements 38 connected respectively to the first lateral support device 20 and the second lateral support device 22 and arranged to support the lower limbs of the supported person.

Each lower support element 38 may translate along the vertical direction y relative to the frame 12 as in the embodiment illustrated in FIG. 3 and/or may rotate relative to the lifting device 24 as in the embodiment illustrated in FIG. 5.

Preferably, the lower support elements 38 are coupled with the distal element 24a of the lifting device 24 in such a way that they are movable along the vertical y direction and can be actuated by the first driver.

The lower support element 38 may be in the form of a rigid, linear element, as illustrated in FIGS. 1 and 2, or it may be L-shaped, as illustrated in FIGS. 5 and 6. The presence of the lower support elements 38 in addition to the lateral support devices 20, 22 advantageously allows the supported person to be supported and moved in a safer and more supportive condition. In addition, having a plurality of support points between the supported person and the reconfigurable system makes it possible to better transfer the weight of the supported person onto the reconfigurable system and be more comfortable for the supported person.

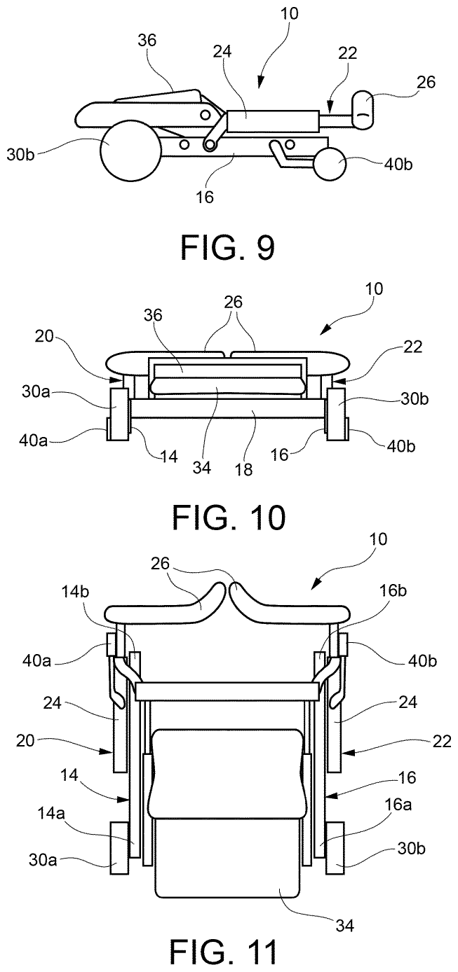

Preferably, the lower support elements 38 can be covered with soft material to be more comfortable for the supported person during use of the reconfigurable system 10. In the embodiment illustrated in FIGS. 9-11, the first side support devices 20 and the second side support device 22, the backrest 36 and the seat 34 can be completely folded or collapsed on the frame 12 in such a way as to make the reconfigurable system 10 compact and prepare it to be easily transported by the supported person or a helper.

The reconfigurable system 10 according to any of the previously described embodiments can be used as a system for the support and ambulation of persons with reduced mobility as will be described below. The reconfigurable system 10 can accommodate a supported person with reduced mobility in such a way that the supported person is seated on the seat and, if necessary, leaning against the backrest 36. Initially, the reconfigurable system 10 can be arranged in such a way that the first lifting means 24, 20 and the second lateral support means 22 are in a rest position. In this condition, the second driver 32 may be activated to actuate the wheels and move the reconfigurable system 10 where desired.

When the supported person wishes to get up from the reconfigurable system 10 and walk around, the lifting devices 24 are activated by the first driver 28. The lifting devices 24 then move from the rest position to the operating position, i.e. they extend along the vertical y-direction, so that the armrests 26 engage with the supported person's armpit, lifting the supported person to an upright position suitable for walking.

Should the supported person wish to move from the reconfigurable system 10 to an external seating element 11 such as a bed or toilet, in addition to the operation of lifting devices 24 as described above, also the lower support elements 38 may also be actuated by the first driver 28 in such a way as to assist the lifting action 24 of the supported person by the lateral support devices 20, 22 and facilitate the transit of the supported person from the reconfigurable system 10 to the external seating element 11. In this case, the two rear wheels 30c, 30d move from the first position in which they are perpendicular to the plane xz to the second position in which the rear wheels 30c, 30d are parallel to the plane xz so that the reconfigurable system 10 rests at the rear on the small wheels 40a, 40b and can advantageously slip underneath the seating element 11.

The present invention also describes a loading apparatus for loading the reconfigurable system 10 into a loading space of a motor vehicle. The apparatus comprises the reconfigurable system 10 according to any of the previously described claims and a loading system configured to be arranged in a cargo space of a motor vehicle and engage with the reconfigurable system 10.

The loading system comprises a first element fixed and disposed in the cargo space of the motor vehicle and a plurality of second elements telescopically movable relative to the fixed element, arranged to engage with the arms 26 of the side support devices 20, 22 of the reconfigurable system 10, and configured to have a rest position in which the plurality of second elements are overlapped and an operating position in which the plurality of second elements are extended.

Preferably, the second elements are telescopically movable relative to the fixed element so as to extend towards a relative rear part of the motor vehicle, i.e. out of the load space of the motor vehicle and facilitate the engagement of the reconfigurable system 10 with the loading system and the resulting relative loading into the cargo space.

In a form of embodiment, the loading system may further comprise third driver configured to actuate the second telescopically movable elements such that they extend predisposed for engagement with the reconfigurable system 10. Preferably, to be engaged with the second telescopically movable elements of the loading system, the reconfigurable system 10 may be in the embodiment wherein the first side support device 20 and the second side support device 22, the backrest 36 and the seat 34 are fully folded or collapsed onto the frame 12.

The loading equipment can be used as follows. The loading apparatus may be arranged in a loading space of a motor vehicle in such a manner that the first element is fixed in the loading space of the motor vehicle and the plurality of second elements are telescopically movable relative thereto. The third driver are actuated such that the second telescopically movable elements are actuated and extended, preparing for engagement with the reconfigurable system 10. Thus, the arms 26 of the reconfigurable system 10 are engaged with the second telescopically movable elements such that the reconfigurable system 10 is loaded into the load space of the motor vehicle.

In a form of embodiment, the first lateral supporting device 20 and the second lateral supporting device 22 may include a self-tightening mechanism of the armrest when a patient is suspended on them. As illustrated in FIGS. 12 and 13, the armrest's support mechanisms such as support mechanism 41 are inclined inwardly with respect to a vertical direction y. The support mechanism 41 comprises a tunnel for receiving a boss 42 of the arm rest 26. In a preferred embodiment, boss 42 extends perpendicularly from the primary longitudinal axis of the arm rest 26. Boss 42 is substantially circular in cross-section whereas the tunnel of self-tightening mechanism 41 is substantially rectangular in cross-section. Although not visible in the figure, the tunnel is mounted to the lateral supporting mechanism by virtue of pivot. In this manner, the more load is applied at the tips of the armrest 26, the more they tighten towards the torso of the supported person, preventing the accidental opening of the armrests and the subsequent fall of the person who is using the reconfigurable system 10. As illustrated in FIG. 13 the armrests 26 can change insert height, and be more or less inclined with respect to a vertical direction y.

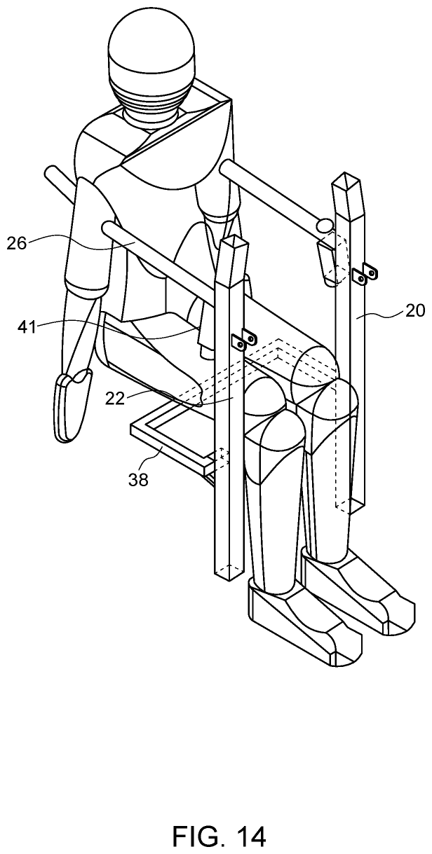

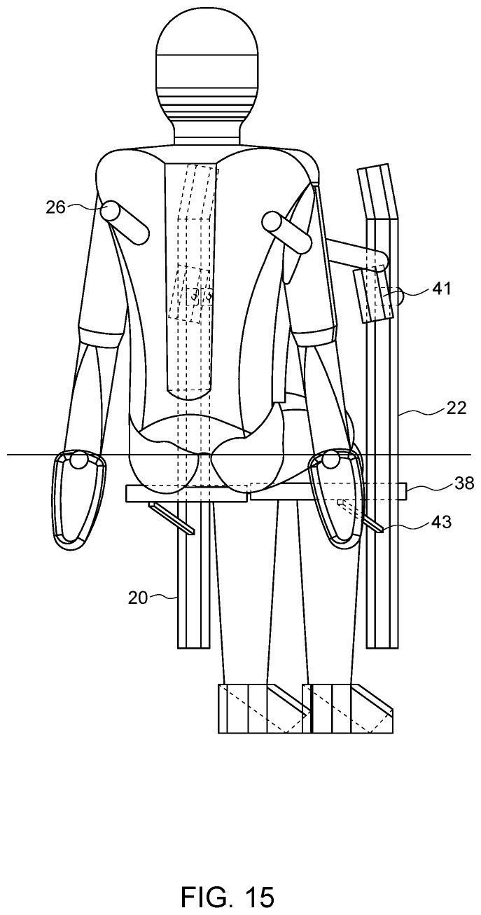

In a further embodiment, a lower support element 38, is provided in a single unitary piece and may optionally be in a U-shape, as illustrated in FIGS. 14 and 15. The presence of the lower support elements 38, in addition to the lateral support devices 20, 22 advantageously allows the supported person to be supported under its legs. Furthermore, the U-shaped lower support element is configured to engage the underside of the leg in the upper region which adjoins the buttocks of the person in need of support. The lower support member is optionally releasably attached to the upwardly extending lateral support devices. Alternatively, the U-shaped lower support element may be pivotally secured to the upwardly extending lateral support devices. In a further embodiment, an actuator 43 or a driver may be provided extending between the lateral support device 22 and the lower support element 38. The actuator may facilitate the displacement of the lower support element to and from its position in which it supports the person. This may include an electro-mechanical element, a pneumatic ram or an electric actuator for modifying the position as appropriate. This allows the support element to replace for a time the collapsed seat without occupying much of the vacated space thus allowing the system to be brought in close proximity to objects such as a toilet or bed as desired. Once the object and the system are in close proximity the actuator may be actuate to cause the removal of the lower support member to facilitate the transfer of the individual's weight from the system to the adjacent object.

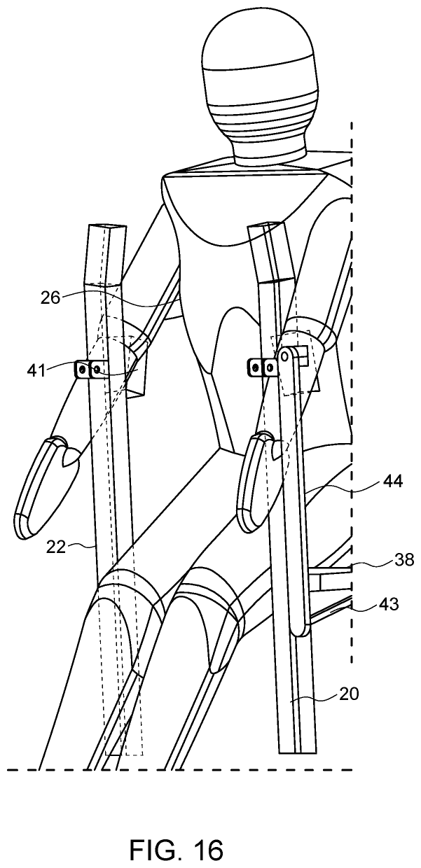

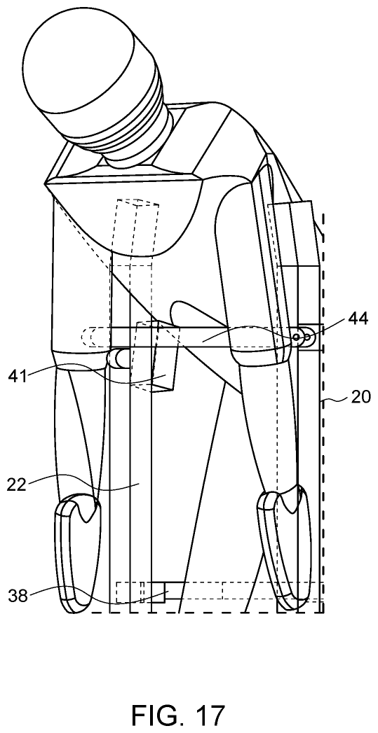

In a further embodiment, a horizontal support element 44, is provided in a single unitary piece, as illustrated in FIGS. 16 and 17. The presence of the horizontal support elements 44, in addition to the lateral support devices 20, 22 advantageously allows the supported person to be supported under its armpits while remaining with its legs outstretched. This position will make it easier for the operator should it be necessary to change the patient's trousers and/or clean up after the patient's physiological needs.

Preferably, the horizontal support element 44 has an elongated shape and when the lifting device 24 is in the resting position, the horizontal support element 44 is parallel to the vertical direction y, as illustrated in FIG. 16. When the lifting device is in the operating position, the horizontal support element 44 is parallel to the transverse direction z, extending between the first lateral support device (20) and the second lateral support device 22, as shown in FIG. 17. The horizontal support element 44 is brought into its closed position through a rotation of 270 degrees from its open position, rotating around a bolt screwed onto the lateral support device 20. On the lateral support device 22 is welded a U-shaped plate, which accommodates the horizontal support element 44 in its central space, coupled with a pin that locks the element 44 in its closed position

As for the armrest, also the horizontal support element 44 may advantageously be made of or covered with soft material, for example padded or resilient material, such that it is comfortable for the person using it as a support.

It is to be understood that the invention is not limited to the embodiments described and illustrated herein, which are to be considered as examples of implementations of the reconfigurable system; instead, the invention is susceptible to modifications relating to shape, dimensions and arrangement of parts, construction details and materials used.

1. A reconfigurable system for supporting a person with reduced mobility, comprising:
a frame comprising a first arm and a second arm extending along a longitudinal direction (x), parallel and spaced apart, each having a front end and a rear end, the frame further comprising a third arm extending along a transverse direction to the longitudinal direction (x), arranged so as to rigidly connect said first and second arms to each other;
a first lateral support device and a second lateral support device, at least one lateral support device comprising:
a lifting device operable between at least one operating position in which the lifting device is extended along a vertical direction (y), and a rest position in which the lifting device is collapsed, and
an armrest connected to a respective distal end of the lifting device and configured to interface with an armpit of the supported person to support at least part of the weight of the supported person;
a leg-rest for supporting at least part of the underside of said person;
a first driver configured for operating a lifting device of the lateral support devices;
four wheels connected to the frame, of which two front wheels are connected at the respective front ends of the first arm and second arm and two rear wheels are connected at the respective rear ends of the first and second arms;
a second driver (32) configured for driving at least two of said wheels;
a collapsible seat;
a third driver to drive the transformation of the collapsible seat into and from its collapsed configuration;
wherein the frame has a rear portion which comprises a vacant space located between said first and second arms; said collapsible seat being configured to collapse into at least part of a front portion of the frame which, when collapsed, increases the vacant space located in said rear portion; said system being further configured so that the person is supported by said armrest and said leg-rest when the collapsible seat is collapsed in order to facilitate, in use, the interaction of the supported person with an object occupying, in use, said vacated space.

2. (canceled)

3. The reconfigurable system of claim 1, wherein the leg-rests extend from the first and second lateral support devices and are configured to interface with at least one of a knee or upper underside region of the person's legs.

4. The reconfigurable system of claim 1, wherein the leg-rests are formed from a junction member extending between said lateral support devices.

5. The reconfigurable system of claim 1, further comprising a driver for displacing the leg-rest from a position where it is spaced from a position of engagement with the underside of a supported person's leg to a position of engagement with the underside of a supported person's leg.

6. The reconfigurable system of claim 1, wherein the system comprises two armrests (26) and at least one of said armrests is adjustably connected to a lifting device; whereby the distance between the two armrests is adjustable.

7. The reconfigurable system of claim 1, wherein the longitudinal direction (x) and the transverse direction (z) define a horizontal plane (xz) and the vertical direction (y) is perpendicular to the horizontal plane (xz), where the lifting devices of the first lateral support and second lateral support device each comprise a proximal element joined respectively to the first arm and second arm of the frame and at least one distal element telescopically movable with respect to the relevant proximal element along the vertical direction (y), away from, or towards, the plane horizontal (xz).

8. The reconfigurable system of 6, wherein the lifting device of the first lateral support device and the lifting device of the second lateral support device are pivotally mounted in relation to the frame.

9. The reconfigurable system of claim 6, wherein when the first lateral support device and the second lateral support device are in the operating position, and wherein said lateral support devices each have an armrest; the armrests are substantially parallel to the horizontal plane (xz) and can be rotated about an axis perpendicular to the (xz) plane.

10. The reconfigurable system of claim 7, further comprising two small wheels having a diameter smaller than the diameter of the two rear wheels and arranged respectively, one on the first arm and one on the second arm in one distal position with respect to said rear wheels; in which said two rear wheels are rotatably supported on swivel pins between a first position where the rear wheels are perpendicular to the (xz) plane and a second position in which the rear wheels are parallel to the plane (xz).

11. The reconfigurable system of claim 1, wherein the collapsible seat comprises a backrest each connected to the frame by a plurality of intermediate elements.

12. The reconfigurable system of claim 1, comprising two lower support elements connected respectively to the first and second lateral support device and predisposed for support the supported person's lower limbs.

13. The reconfigurable system of claim 1, wherein the first driver and the second driver can be operated by the supported person via a control device placed on board the reconfigurable system and/or can be operated remotely via an application.

14. The reconfigurable system of claim 1, wherein the system comprises a single armrest which is sized and shaped to extend between a first lateral support device and a second lateral support device in order to engage with the supported person's armpit.

15. Loading equipment for loading a reconfigurable system in a cargo space of a motor vehicle, comprising:
a reconfigurable system according to any of the preceding claims;
a loading system configured to be arranged in a loading space of a motor vehicle and engage with said reconfigurable system; wherein the loading system comprises a first element fixed and arranged in the loading space of the motor vehicle and a plurality of second elements telescopically mobile with respect to the fixed element, prepared to engage with at least one of the armrests of the lateral support devices of the reconfigurable system, and configured to have a rest position in which the plurality of second elements are overlapped and an operational position in which the plurality of second elements are extended.
